(19) United States
(12) Patent Application Publication
(10) Pub. No.: US 2002/0114575 A1
(43) Pub. Date: Aug. 22, 2002

(54) Optical alignment method for an optical receiver

(75) Inventor: Mark Owen, Cardiff (GB)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor AB, Jarfalla (SE)

(21) Appl. No.: 10/044,170

(22) Filed: Oct. 26, 2001

(30) Foreign Application Priority Data
Oct. 31, 2000 (GB) 0026639.5

(51) Int. Cl. G02B 6/30; G02B 6/26

(52) U.S. Cl. 385/49; 385/43

(57) ABSTRACT

An optical taper is used to couple an optical fiber to the active area of an optical receiver,. The optical taper funnels light from the optical fiber through optical taper to the optical receiver and in this way facilitates alignment of the optical fiber.

### BACKGROUND OF THE INVENTION

1. Field of the Invention

This invention relates to the field of optical communications, and in particular a method of optically coupling a waveguide with a receiver, and an optical coupling for practicing the method.

2. Description of Related Art

In the telecommunications field, optical fibers (single mode, multi mode, or plastic optical fibers (POF)) are increasingly replacing copper wire as the communications medium of choice. High speed optical receivers receive pulses of light from the optical fibers and convert them to electrical signals. At high speeds, the receivers, which are typically photodiodes or PIN diodes can be very difficult and expensive to align with the detector. This is because at high speeds the PINs (GHz) require small active areas, anywhere from 0.1 to 0.001 mm in diameter depending on operating speed, in order to reduce the capacitance of the detector. The tolerance in the fiber alignment process during manufacture must be at least an order of magnitude better than this detector area. As a result, sub micron tolerances are required to avoid optical power loss due to misalignment. This makes fiber alignment packaging very expensive. Currently, there are two approaches to this problem. In active alignment, the incoming optical fiber or the PIN diode are physically moved into the correct location by actively measuring the power coupled between the fiber and detector. When the power is at a maximum, the components are fixed, for example, by gluing or welding, into place. This is an expensive technique, which is generally used in high speed telecommunications/single fiber mode applications.

In the passive alignment technique, the fiber or PIN diode is fixed to an accurately machine subassembly. The PIN diode or fiber is then passively aligned by using some form of solder reflow or mechanical mechanism. No form of active measurement is required. The laws of physics are relied on to lead the PIN diode or fiber into the correct position. This technique nevertheless still requires that very strict tolerances are met.

### SUMMARY OF THE INVENTION

According to the present invention there is provided a method of optically coupling an optical waveguide with an optical receiver, comprising providing an optical taper having an input end and an output end over an active area of the receiver, aligning the optical fiber with said input end of said optical taper, and funneling light from said optical waveguide through said output end of said optical taper to said active area of said optical receiver.

Suitably the optical waveguide is an optical fiber.

In accordance with the principles of the invention, the optical taper funnels the light emitted from the fiber towards the active area of the detector, and in this way relaxes the alignment tolerances between the fiber and detector, thereby making manufacture easier and cheaper. The optical taper can have any suitable shape. Typically it will be cone-shaped, but it does not have to be in the form of a linear taper. It can be pyramid shaped, or it can be curved, in the manner of the flute shape on the end of a trumpet.

The optical taper may be in the form of a hole formed in a sheet, such as a metal foil, or it may be a shaped transparent dielectric piece.

In another aspect the invention also provides an optical coupling comprising an optical fiber having an output end, a receiver having an active area, and an optical taper having an input end and an output end, said input end being aligned with said output end of said optical fiber, whereby said optical coupling tunnels light from said optical fiber into said active area of said optical receiver.

The hole can be formed by etching into a metal foil, or alternatively it can be etched into a crystalline material, such as silicon, and then metallized to provide the optical taper. If the active area of the PIN is more than the area of the output end of the taper, then the PIN doesn't have to be accurately aligned to the taper. The important point is that it is no longer necessary to align the fiber to the same degree of precision.

### BRIEF DESCRIPTION OF THE DRAWINGS

The invention will now be described in more detail, by way of example only, with reference to the accompanying drawings, in which:

FIG. 1 is a schematic diagram of an optical coupling according to a first embodiment of the invention;

FIG. 2 is a schematic diagram of an optical coupling according to a second embodiment of the invention; and

FIG. 3 is a graph showing theoretical taper loss against surface roughness.

### DETAILED DESCRIPTION OF THE PREFERRED EMBODIMENTS

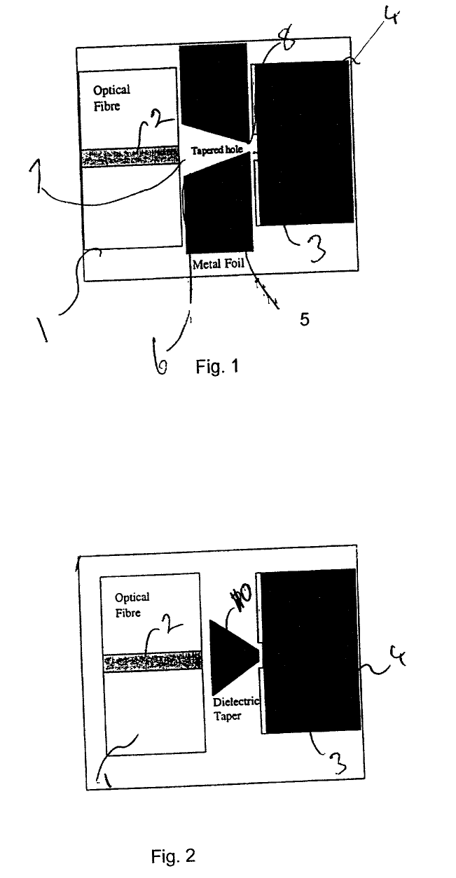

Referring now to FIG. 1 an optical fiber 1 has a core 2 emitting light pulses that need to be directed into active area 3 of optical receiver 4, for example a photo guide or PIN diode. In view of the small active area GHz frequency, sub micron tolerances are required.

A metal foil 5 having a tapered hole 6, forming an optical taper, is located between the optical fiber 1 and the optical receiver 4. The metal foil is aligned to the PIN 2 using a solder reflow technique or the like. The optical taper has a wide end 7 providing an input and a narrow end 8 providing an output. The output end 8 lies over the active area 3 of the optical receiver 4.

It will be seen in FIG. 1 that it is no longer necessary to precisely align the core 2 of the optic fiber 1 since so long as the wider input end of the optical taper extends over the core 2, light emitted from the core 2 will be funneled through the optical taper into the active area 3 of the optical receiver 4. The optical taper thus has the effect of relaxing the tolerance required for aligning the optical fiber 1 in high frequency applications. The technique is still however effective in low frequency applications. It permits smaller PINs, which are cheaper to manufacture.

FIG. 2 shows an alternative embodiment that is similar to FIG. 1 except that the optical taper is provided by a cone shaped dielectric piece 10. The dielectric piece 10 is made of transparent material, such as glass, or a material of higher refractive index. The optical taper 10 serves the same purpose as the hole 7. It funnels the light from the core 2 of the optical fiber 1 into the active area 3 of the optical receiver 4. A dielectric taper is preferred since it introduces less loss, although it is more difficult to manufacture. As in FIG. 1, the dielectric material 10 still has to be aligned with the active area 3.

The simplest method of manufacturing the optical taper in accordance with the invention is to chemically etch a small hole into a metal foil. An etched hole in the metal naturally forms a wider aperture on the far side of the foil. The foil will typically be masked on the near side.

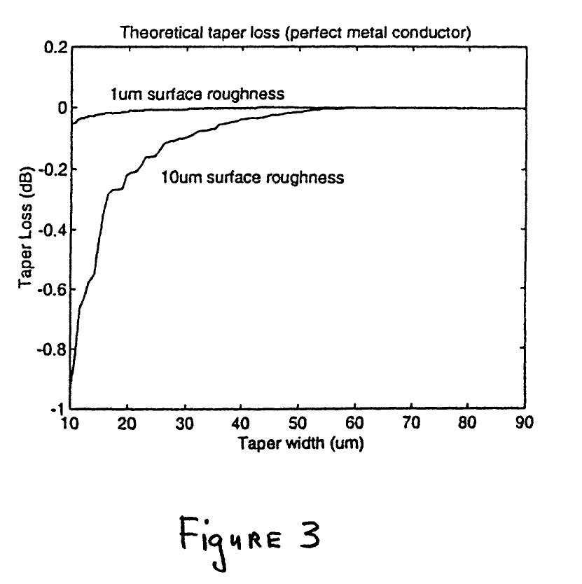

A potential problem with this method is surface roughness on the walls of the taper causing too much optical loss. FIG. 3 shows the theoretical taper loss in decibels for different taper surface roughness. One solution to this problem is to wet etch a crystalline material, such as silicon, to form a hole in the crystal with near perfect sidewalls. The hole is then plated with metal to form the optical taper. The reflectivity of metal may not be high enough to make this possible, in which case the dielectric approach should be used.

In multimode fibers and plastic optical fiber applications, bit rates are increasing rapidly. This implies an ever decreasing size in the active area of the PIN diodes inside the optical receivers in order to meet the increasing bandwidth requirements. Smaller PIN active areas mean less capacitance in the diode, which in turn translates the higher speed performance. At the current rates of increase, future optical receivers will probably require PIN active areas smaller than the optical spot size emitted from an optical fiber. Spot size of the fiber is fixed and cannot be reduced. This is a particular problem with plastic optical fiber that has very large spot sizes, 0.1 mm or more. The invention can also be used to reduce the spot size emitted from these fibers so that it has the same dimensions as the active area of the PIN diode, i.e. in the order of 0.1 to 0.01 mm. The invention also addresses this problem by using the optical taper to convert a larger optical spot to a smaller optical spot for electrical detection at high speeds.

The same functionality could also be achieved by tapering the end of the fiber, for example, by chemical etching or polishing, to achieve the same functionality.

The technique is not limited to optical fibers. For example, it may be used with any optical waveguide. For example, it can be used on optical PCBs or optical Ics.

It will be seen therefore that the invention provides an effective method of coupling an optical fiber to a photo detector for high speed applications while relaxing the tolerance requirements that the dimensions of the active area of the receiver would imply.

Although the invention has been described and illustrated in detail, it is clearly understood that the same is by way of illustration and example only and Is not to be taken by way of limitation, the spirit and scope of the present invention being limited only by the terms of the appended claims.

I claim:

1. A method of optically coupling an optical waveguide with an optical receiver, comprising:
providing an optical taper having an input end and an output end over an active area of the receiver;
aligning the optical waveguide with said input end of said optical taper; and
funneling light from said optical waveguide through said output end of said optical taper to said active area of said optical receiver.

2. A method as claimed in claim 1, wherein said optical taper is defined by a tapered hole formed in a metallized sheet located between said optical waveguide and said optical receiver.

3. A method as claimed in claim 2, wherein said metallized sheet is a metal foil.

4. A method as claimed in claim 3, wherein said tapered hole is chemically etched in said metal foil.

5. A method as claimed in claim 2, wherein said hole is etched in a crystalline material, and the resulting etched hole is metallized to provide said optical taper.

6. A method as claimed in claim 5, wherein said crystalline material is silicon.

7. A method as claimed in claim 6, wherein said hole is formed by a wet etch.

8. A method as claimed in claim 2, wherein said optical taper is defined by a shaped transparent dielectric material located between the optical fiber and the optical receiver.

9. A method as claimed in claim 1, wherein the taper is linear.

10. A method as claimed in claim 9, wherein the optical taper is cone-shaped.

11. A method as claimed in claim 9, wherein the optical taper is pyramid-shaped.

12. A method as claimed in claim 1, wherein said optical waveguide is an optical fiber.

13. An optical coupling comprising:
an optical waveguide having an output end;
a receiver having an active area; and
an optical taper having an input end and an output end, said input end being aligned with said output end of said optical waveguide, whereby said optical coupling funnels light from said optical waveguide into said active area of said optical receiver.

14. An optical coupling as claimed in claim 13, wherein said optical taper is defined by a hole formed in a metallized sheet located between said optical waveguide and said optical receiver.

15. An optical coupling as claimed in claim 14, wherein said metallized sheet is a metal foil.

16. An optical coupling as claimed in claim 15, wherein said optical taper is defined by a hole formed in formed in a crystalline material and having a metallized surface.

17. An optical coupling as claimed in claim 16, wherein said crystalline material is silicon.

18. An optical coupling as claimed in claim 13, wherein said optical taper is defined by a shaped transparent dielectric material located between the optical fiber and the optical receiver.

19. An optical coupling as claimed in claim 18, wherein the taper is linear.

20. An optical coupling as claimed in claim 19, wherein the optical taper is cone-shaped.

21. An optical coupling as claimed in claim 20, wherein the optical taper is pyramid-shaped.

22. An optical coupling as claimed in claim 13, wherein said optical waveguide is an optical fiber.
